(19) United States
(12) Patent Application Publication
(10) Pub. No.: US 2026/0015516 A1
(43) Pub. Date: Jan. 15, 2026

(54) INK SET, INKJET RECORDING APPARATUS, AND IMAGE FORMING METHOD

(71) Applicant: KYOCERA DOCUMENT SOLUTIONS INC., OSAKA (JP)

(72) Inventor: MOTONOBU SUGIMOTO, OSAKA (JP)

(21) Appl. No.: 19/264,815

(22) Filed: Jul. 9, 2025

(30) Foreign Application Priority Data
Jul. 10, 2024 (JP) 2024-111016

(51) Int. Cl. C09D 9/00; B41J 2/165; C09D 11/40

(52) U.S. Cl. CPC C09D 9/005; B41J 2/16552; C09D 11/40; B41J 2002/16558; B41P 2235/21

(57) ABSTRACT

An ink set includes: an inkjet ink; and a cleaning solution, the inkjet ink including a pigment and an aqueous medium, a drying ratio of the inkjet ink when left to stand at 40° C. for 24 hours being 87 mass % or more and 93 mass % or less, the cleaning solution including diethylene glycol butyl methyl ether and trihydric or higher polyhydric alcohol.

### CROSS-REFERENCE TO RELATED PATENT APPLICATION

This application claims the benefit of Japanese Priority Patent Application JP 2024-111016 filed Jul. 10, 2024, the entire contents of which are incorporated herein by reference.

### FIELD OF THE DISCLOSURE

The present disclosure relates to an ink set, an inkjet recording apparatus, and an image forming method.

### BACKGROUND OF THE DISCLOSURE

In recent years, highly drying inkjet inks have been used to accelerate the fixation thereof for the purpose of achieving a faster printing speed. Highly drying inkjet inks with a lot of volatile component strongly adheres to a substrate upon drying. In particular, inkjet inks using pigments are not redissolved once they have solidified due to the evaporation of moisture.

For this reason, when such an inkjet ink adheres to an ink ejection surface (referred to also as a nozzle surface) of a recording head and dries, nozzles provided on the ink ejection surface become clogged, which causes a problem of a decrease in the ejection stability of the inkjet ink.

In particular, inkjet inks for offset coated paper and inkjet inks for label packaging include binder resins in order to improve the fixability of a recording medium to the substrate. When a highly drying inkjet ink including a binder resin adheres to the ink ejection surface of the recording head and dries, it strongly adheres to the ink ejection surface and cannot be removed easily.

For this reason, for an ink set and an inkjet recording apparatus that include a highly drying inkjet ink and cleaning solution, it is desired to be capable of easily removing the solidified highly drying inkjet ink (specifically, the solidified highly drying inkjet ink adhered to the ink ejection surface of the recording head) by washing (cleaning).

As an example of an ink set that aims to prevent non-ejection of ink due to the nozzle clogging of the recording head and maintain stable ejection performance of the recording head, Japanese Patent No. 5566741 discloses an ink set including, for example, an ink (ink composition) that includes water, a pigment, and a polymer particle, and a cleaning solution (maintenance solution) that includes propylene glycol monopropyl ether. In Japanese Patent No. 5566741, as a specific cleaning solution, a cleaning solution that includes propylene glycol monopropyl ether, a nonionic surfactant, and water is used.

### SUMMARY OF THE DISCLOSURE

An ink set according to the present disclosure includes: an inkjet ink; and a cleaning solution. The inkjet ink includes a pigment and an aqueous medium. A drying ratio of the inkjet ink when left to stand at 40° C. for 24 hours is 87 mass % or more and 93 mass % or less. The cleaning solution including diethylene glycol butyl methyl ether and a trihydric or higher polyhydric alcohol.

An inkjet recording apparatus according to the present disclosure includes: an inkjet ink; a cleaning solution; and a recording head. The recording head includes a recording unit that ejects the inkjet ink onto an image forming region of a recording medium, and a cleaning unit that cleans an ink ejection surface of the recording unit with the cleaning solution. A drying ratio of the inkjet ink when left to stand at 40° C. for 24 hours is 87 mass % or more and 93 mass % or less. The cleaning solution includes diethylene glycol butyl methyl ether and a trihydric or higher polyhydric alcohol.

An image forming method according to the present disclosure includes: an ejection step of ejecting an inkjet ink onto a recording medium from an ink ejection surface of a recording head; and a cleaning step of cleaning the ink ejection surface with a cleaning solution. The inkjet ink includes a pigment and an aqueous medium. A drying ratio of the inkjet ink when left to stand at 40° C. for 24 hours is 87 mass % or more and 93 mass % or less. The cleaning solution includes diethylene glycol butyl methyl ether and a trihydric or higher polyhydric alcohol.

### BRIEF DESCRIPTION OF THE DRAWINGS

FIG. 1 is a diagram showing a main part of an inkjet recording apparatus that is an example of an inkjet recording apparatus according to this embodiment.

FIG. 2 is a diagram showing lower surfaces of a recording head and a head housing in FIG. 1.

FIG. 3 is a diagram showing a side surface of a first recording head in FIG. 1.

FIG. 4 is a diagram showing a series of cleaning steps of a cleaning operation by the inkjet recording apparatus.

FIG. 5 is a diagram showing the series of cleaning steps of the cleaning operation by the inkjet recording apparatus.

FIG. 6 is a diagram showing the series of cleaning steps of the cleaning operation by the inkjet recording apparatus.

FIG. 7 is a diagram showing the series of cleaning steps of the cleaning operation by the inkjet recording apparatus.

### DETAILED DESCRIPTION OF THE EXEMPLARY EMBODIMENTS

Embodiments of the present disclosure will be described below in detail. However, the present disclosure is not limited to the following embodiments. The present disclosure may be modified in various ways within the essence of the present disclosure, and embodiments obtained by appropriately combining the technical means described in different embodiments are also included in the technical scope of the present disclosure.

In the following, the measured value of the volume median diameter (D50) is a value measured using a dynamic light scattering particle size distribution analyzer (e.g., “Zetasizer (registered trademark) Nano ZS” manufactured by Malvern Panalytical Ltd.), unless otherwise specified.

In the present specification, acrylic and methacrylic are collectively referred to as “(meth)acrylic” in some cases. Each component described in the present specification may be used alone or two or more of them may be used in combination. Further, in the present specification, the phrase “at least one of A or B” means “A and/or B”. The phrase “A and/or B” means “A, B, or A and B”.

### First Embodiment: Ink Set

An ink set according to a first embodiment of the present disclosure will be described below. The ink set according to this embodiment includes an inkjet ink (hereinafter, referred to simply as an ink in some cases) and a cleaning solution. The ink includes a pigment and an aqueous medium. The drying ratio of the ink when left to stand at 40° C. for 24 hours is 87 mass % or more and 93 mass % or less. The cleaning solution includes diethylene glycol butyl methyl ether and a trihydric or higher polyhydric alcohol.

The ink included in the ink set according to this embodiment is a highly drying ink that includes a pigment and an aqueous medium, the drying ratio of the ink when left to stand at 40° C. for 24 hours being 87 mass % or more and 93 mass % or less, as described above. By leaving the ink at 40° C. for 24 hours, the drying ratio of the ink is saturated. Therefore, the drying ratio of the ink when left to stand at 40° C. for 24 hours indicates the drying ratio of the ink when the drying ratio of the ink reached the maximum value. By having the above-mentioned configuration, the ink set according to this embodiment allows the solidified product of the above-mentioned highly drying ink to be removed easily by washing (cleaning). The reason why the ink set according to this embodiment has the above-mentioned effect is presumed to be as follows.

The cleaning solution of the ink set according to this embodiment includes diethylene glycol butyl methyl ether and a trihydric or higher polyhydric alcohol. When diethylene glycol butyl methyl ether and a trihydric or higher polyhydric alcohol are used together in the cleaning solution in this way, the diethylene glycol butyl methyl ether included in the cleaning solution is easily absorbed into the solidified ink. As a result, it is possible to induce volumetric distortion in the solidified ink and weaken the adhesion force of the solidified ink to the ink ejection surface of the recording head.

Further, the trihydric or higher polyhydric alcohol has the effect of destabilizing diethylene glycol butyl methyl ether in the cleaning solution. Note that destabilizing diethylene glycol butyl methyl ether in the cleaning solution the trihydric or higher polyhydric alcohol means that the trihydric or higher polyhydric alcohol weakens the interaction between diethylene glycol butyl methyl ether and hydration water. By destabilizing diethylene glycol butyl methyl ether in the cleaning solution, the absorption of ink stains by diethylene glycol butyl methyl ether can be effectively enhanced. As a result, it is possible to further improve the cleaning power of diethylene glycol butyl methyl ether.

For the reasons described above, the ink set according to this embodiment allows the solidified ink to be peeled off and removed easily even if it is the solidified product of a highly drying ink that is difficult to dissolve or disperse in a solvent. As described above, the cleaning solution that includes diethylene glycol butyl methyl ether and a trihydric or higher polyhydric alcohol has excellent performance for removing the solidified product of a highly drying ink. For this reason, by combining the above-mentioned ink and the above-mentioned cleaning solution, it is possible to provide an ink set that is capable of easily removing the solidified product of a highly drying ink by cleaning. The ink set according to this embodiment will be described below in more detail.

### Ink

The ink included in the ink set according to this embodiment includes at least a pigment and an aqueous medium. The ink favorably further includes at least one of a pigment coating resin, a binder resin particle, and a surfactant.

### Drying Ratio

The ink included in the ink set according to this embodiment is a highly drying ink, the drying ratio of the highly drying ink when left to stand at 40° C. for 24 hours (hereinafter, referred to simply as a drying ratio of the ink in some cases) being 87 mass % or more and 93 mass % or less. In this embodiment, the drying ratio of the ink indicates the percentage of the ink mass that has decreased due to the drying of the ink by the evaporation of vaporization components in the ink after the ink is left to stand at 40° C. for 24 hours.

Specifically, the drying ratio of the ink represents the ratio of the ink mass that has decreased due to drying to the ink mass before drying, which is obtained by the following formula (i).

$$Drying ratio of ink = 100 \times ( {W}_{0} - {W}_{1} ) / {W}_{0} \qquad ( i )$$

Note that in the formula (i), W₀ represents the ink mass before drying (before being left to stand at 40° C. for24 hours) and W₁ represents the ink mass after drying (after being left to stand at 40° C. for 24 hours). The ink is typically preserved such that the composition of the ink does not change from the time of production. For this reason, the percentage of the volatile component in the ink does not change with the number of years from the production of the ink. In other words, the number of years from the production of the ink does not affect the drying ratio of the ink. For this reason, the drying ratio of the ink can be calculated easily by measuring the mass of the ink before and after drying. Specifically, the drying ratio of the ink can be calculated by the method shown below.

First, the ink in the ink set to be evaluated is spin coated onto a stainless steel plate at the application rate of 0.7 μL/cm². Subsequently, this stainless steel plate is left to stand at 40° C. for 24 hours to dry the ink, thereby forming a dried thin film on the stainless steel plate. In this case, the ink mass before drying represented by Wo specifically indicates the mass of the ink applied to the stainless steel plate. Further, the ink mass after drying represented by W₁ indicates specifically indicates the mass of the ink that is applied to the stainless steel plate and then left to stand at 40° C. for 24 hours (in other words, the mass of the above-mentioned dried thin film (i.e., solid) of the ink formed on the stainless steel plate).

The ink includes a vaporization component. The vaporization component includes at least a volatile component. The volatile component only may be any of components that are volatile, which are used in inks. As the volatile component, a component that is volatile at 40° C. or less is used. Examples of the volatile component include water and a so-called volatile organic compound (VOC) whose boiling point is in the range of 50° C. to 260° C. However, the volatile component is not limited to water and VOCs. The vaporization component may include, for example, a so-called very volatile organic compound (VVOC) whose boiling point is 50° C. or a semi-volatile organic compound (SVOC) whose boiling point is 260° C. or more.

The content ratio of the volatile component in the ink is favorably 85 mass % or more and 93 mass % or less. By setting the content ratio of the volatile component in the ink to 85 mass % or more, it is possible to obtain an ink set including a highly drying ink that enables high-speed printing. Meanwhile, by setting the content ratio of the volatile component in the ink to 93 mass % or less, it is possible to form an image having desired image density. Further, the cleaning solution allows the ink to be reliably removed from the ink ejection surface of the recording head. As a result, it is possible to optimize the ejection stability of the ink by the inkjet recording apparatus. Note that examples of the volatile component included in the ink include an aqueous medium.

Further, the vaporization component may include a sublimable component. The sublimable component may include, for example, some of pigments, pigment coating resins, or binder resin particles. The composition of the ink is appropriately set such that the content ratio of the solid in the ink, which does not evaporate even when left to stand at 40° C. for 24 hours, is 7 mass % or more and 12 mass % or less. By setting the content ratio of the solid in the ink, which does not evaporate even when left to stand at 40° C. for 24 hours, to 7 mass % or more, it is possible to form an image having desired image density. Further, the cleaning solution allows the ink to be reliably removed from the ink ejection surface of the recording head. As a result, it is possible to optimize the ejection stability of the ink by the inkjet recording apparatus. Meanwhile, by setting the content ratio of the solid in the ink, which does not evaporate even when left to stand at 40° C. for 24 hours, to 12 mass % or less, it is possible to obtain an ink set including a highly drying ink that enables high-speed printing.

### Pigment

Examples of the pigment include a yellow pigment, an orange pigment, a red pigment, a blue pigment, a purple pigment, and a black pigment. Examples of the yellow pigment include C.I. Pigment Yellow (74, 93, 95, 109, 110, 120, 128, 138, 139, 151, 154, 155, 173, 180, 185, and 193). Examples of the orange pigment include C.I. Pigment Orange (34, 36, 43, 61, 63, and 71). Examples of the red pigment include C.I. Pigment Red (122 and 202).

Examples of the blue pigment include C.I. Pigment Blue (15, more specifically 15:3). Examples of the purple pigment include C.I. Pigment Violet (19, 23, and 33). Examples of the black pigment include C.I. Pigment Black (7).

In the ink, the content ratio of the pigment is favorably 2.00 mass % or more and 15.00 mass % or less, more favorably 5.00 mass % or more and 10.00 mass % or less. By setting the content ratio of the pigment to 2.00 mass % or more, it is possible to form an image having desired image density easily. Further, by setting the content ratio of the pigment to 15.00 mass % or less, the ink can be reliably removed from the ink ejection surface of the recording head with the cleaning solution. As a result, it is possible to optimize the ejection stability of the ink by the inkjet recording apparatus.

In the ink, the pigment is disposed in the aqueous medium as a particle (hereinafter, referred to as a pigment particle in some cases). The pigment particle may include only a pigment or may include a pigment and a pigment coating resin that coats the surface of the pigment. In the case where the pigment particle includes a pigment coating resin, the pigment particle includes, for example, a core including a pigment and a pigment coating resin coating the core.

### Pigment Coating Resin

At least part of the pigment coating resin coats the core (pigment portion). The presence of the pigment coating resin on the surface of the pigment particle optimizes the dispersibility of the pigment particle. Note that part of the pigment coating resin may be dissolved or dispersed in the aqueous medium without coating the core.

The pigment coating resin is not particularly limited. However, examples of the pigment coating resin include a (meth)acrylic resin, a styrene-(meth)acrylic resin, a styrene-maleic acid copolymer, a vinyl naphthalene-(meth)acrylic acid copolymer, and a vinyl naphthalene-maleic acid copolymer.

In the case where the ink includes the pigment coating resin, the content ratio of the pigment coating resin in the ink is favorably 0.5 mass % or more and 4.0 mass % or less, more favorably 0.5 mass % or more and 1.5 mass % or less.

Further, in the case where the ink includes the pigment coating resin, the content of the pigment coating resin with respect to 100.0 parts by mass of the pigment in the ink is favorably 10.0 parts by mass or more and 60.0 parts by mass or less, more favorably 20.0 parts by mass or more and 30.0 parts by mass or less.

From the viewpoint of optimizing the color density, hue, or stability of the ink, the volume median diameter (D50) of the pigment particle is favorably 30 nm or more and 300 nm or less, more favorably 70 nm or more and 130 nm or less.

### Binder Resin Particle

The binder resin particle functions as a binder in an image formed with the ink. The binder resin particle binds the pigment in the ink to the recording medium after impact, thereby improving the fixability of the pigment to the recording medium. The binder resin particle is present in a dispersed state in the aqueous medium. The binder resin particle is contained in the ink in, for example, the form of emulsion (emulsified particle). For this reason, for example, an emulsified particle formed of the binder resin particle is dispersed in the ink.

Examples of the binder resin particle include particles of a urethane resin, a (meth)acrylic resin, a urethane-(meth)acrylic resin, a polyester resin, a styrene-(meth)acrylic resin, a styrene-maleic acid copolymer, a vinyl naphthalene-(meth)acrylic acid copolymer, and a vinyl naphthalene-maleic acid copolymer. As the binder resin particle, a particle of a urethane resin or a urethane-(meth)acrylic resin is favorable.

The content ratio of the binder resin particle in the ink is favorably 1.0 mass % or more and 10.0 mass % or less, more favorably 3.0 mass % or more and 7.0 mass % or less. By setting the content ratio of the binder resin particle to 1.0 mass % or more, it is possible to improve the fixability of the pigment to the recording medium. Meanwhile, by setting the content ratio of the binder resin particle to 10.0 mass % or less, the ink can be reliably removed from the ejection surface of the recording head with the cleaning solution. As a result, it is possible to optimize the ejection stability of the ink by the inkjet recording apparatus.

### Surfactant

The surfactant optimizes the compatibility and dispersion stability of each component included in the ink. Further, the surfactant optimizes the permeability (wettability) of the ink into the recording medium. Examples of the surfactant include a nonionic surfactant.

Examples of the nonionic surfactant include an acetylene glycol surfactant (surfactant including an acetylene glycol compound), a silicone surfactant (surfactant including a silicone compound), and a fluorosurfactant (surfactant including a fluoropolymer or a fluorine-containing compound). As the nonionic surfactant, an acetylene glycol surfactant is favorable. Examples of the acetylene glycol surfactant include an ethylene oxide adduct of acetylene glycol and a propylene oxide adduct of acetylene glycol. As the acetylene glycol surfactant, an ethylene oxide adduct of acetylene glycol is favorable.

In the case where the ink includes the surfactant, the content ratio of the surfactant in the ink is favorably 0.1 mass % or more and 2.0 mass % or less, more favorably 0.2 mass % or more and 0.6 mass % or less.

### Aqueous Medium

The aqueous medium included in the ink is a medium including water. The aqueous medium may function as a solvent or a dispersion medium. Specific examples of the aqueous medium include an aqueous medium that includes water and a water-soluble organic solvent.

### Water

Water is a main solvent of the ink. The content ratio of water in the ink is favorably 60.0 mass % or more and 90.0 mass % or less, for example.

### Water-Soluble Organic Solvent

The ink favorably further includes a water-soluble organic solvent. Examples of the water-soluble organic solvent include a glycol compound, a glycolether compound, a lactam compound, a nitrogen-containing compound, an acetate compound, thiodiglycol, glycerin, and dimethylsulfoxide.

Examples of the glycol compound include ethylene glycol, 1,3-propanediol, propylene glycol, 1,2-pentanediol, 1,5-pentanediol, 1,2-octanediol, 1,8-octanediol, 3-methyl-1,3-butanediol, 3-methyl-1,5-pentanediol, diethylene glycol, triethylene glycol, and tetraethylene glycol.

Examples of the glycolether compound include diethylene glycol diethylether, diethylene glycol monobutylether, ethylene glycol monomethylether, ethylene glycol monobutylether, diethylene glycol monomethylether, diethylene glycol monoethylether, diethylene glycol diethylether, triethylene glycol monomethylether, triethylene glycol monoethylether, triethylene glycol monobutylether, and propylene glycol monomethylether.

Examples of the lactam compound include 2-pyrrolidone and N-methyl-2-pyrrolidone.

Examples of the nitrogen-containing compound include 1,3-dimethylimidazolidinone, formamide, and dimethylformamide.

Examples of the acetate compound include diethylene glycol monoethyl ether acetate.

As the water-soluble organic solvent, a glycol compound or a glycol ether compound is favorable, and propylene glycol and/or diethylene glycol monoethyl ether is more favorable.

The content ratio of the water-soluble organic solvent in the ink is favorably 3.0 mass % or more and 30.0 mass % or less, more favorably 5.0 mass % or more and 20.0 mass % or less.

The content ratio of propylene glycol in the ink is favorably 1.0 mass % or more and 15.0 mass % or less, more favorably 1.0 mass % or more 8.0 mass % or less.

The content ratio of diethylene glycol monoethyl ether in the ink is favorably 3.0 mass % or more and 20.0 mass % or less, more favorably 5.0 mass % or more and 15.0 mass % or less.

In the aqueous medium, the total content ratio of water, propylene glycol, and diethylene glycol monoethyl ether is favorably 90 mass % or more, more favorably 99 mass % or more, and still more favorably 100 mass %.

### Other Components

The ink may further include, as necessary, known additives (e.g., a dissolution stabilizer, an anti-drying agent, an antioxidant, a viscosity adjustor, a pH adjuster, and an antifungal agent).

### Method of Producing Ink

The ink can be produced by uniformly mixing, using a stirrer, a pigment dispersion liquid including a pigment particle, a binder resin particle dispersion liquid (e.g., a resin emulsion) including a binder resin, an aqueous medium, and another component added as necessary (e.g., a surfactant), for example. Note that in the production of the ink, after uniformly mixing the respective components, foreign substances and coarse particles may be removed using a filter (e.g., a filter with a pore size of 5 μm or less).

### Pigment Dispersion Liquid

The pigment dispersion liquid is a dispersion liquid including a pigment particle. The pigment dispersion liquid favorably further includes a pigment coating resin. As the dispersion medium of the pigment dispersion liquid, water is favorable.

The content ratio of the pigment in the pigment dispersion liquid is favorably 5.0 mass % or more and 25.0 mass % or less, more favorably 15.0 mass % or more and 20.0 mass % or less. In the case where the pigment particle includes a pigment coating resin, the content ratio of the pigment coating resin in the pigment dispersion liquid is favorably 1.0 mass % or more and 10.0 mass % or less.

The pigment dispersion liquid can be prepared by wet dispersing, using a media-type wet disperser, a pigment, a dispersion medium (e.g., water), and a component added as necessary (e.g., a pigment coating resin and/or a surfactant). Note that as the pigment dispersion liquid, a commercially available pigment dispersion liquid may be used.

In the case where a pigment dispersion liquid is added in the production of the ink, the ratio of the pigment dispersion liquid to all the raw materials of the ink is, for example, 10.0 mass % or more and 40.0 mass % or less.

### Cleaning Solution

The cleaning solution of the ink set according to this embodiment includes, as an organic solvent, diethylene glycol butyl methyl ether and a trihydric or higher polyhydric alcohol. Note that the cleaning solution favorably includes water as a main solvent.

### Diethylene Glycol Butyl Methyl Ether

Diethylene glycol butyl methyl ether allows the adhesion force of the solidified ink to be weaken by being adsorbed into the solidified ink. For this reason, diethylene glycol butyl methyl ether imparts excellent cleaning performance to the cleaning solution.

The content ratio of diethylene glycol butyl methyl ether in the cleaning solution is favorably 1 mass % or more and 8 mass % or less, more favorably 4 mass % or more 8 mass % or less. By setting the content ratio of diethylene glycol butyl methyl ether in the cleaning solution to 1 mass % or more, it is possible to impart more excellent cleaning performance to the cleaning solution. Further, by setting the content ratio of diethylene glycol butyl methyl ether in the cleaning solution to 8 mass % or less, it becomes easier to ensure the compatibility between diethylene glycol butyl methyl ether and other components (e.g., water and a polyhydric alcohol).

### Polyhydric Alcohol

Examples of the trihydric or higher polyhydric alcohol included in the cleaning solution include sorbitol, glycerin, trimethylolethane, trimethylolpropane, pentaerythritol, dipentaerythritol, tripentaerythritol, 1,2,4-butanetriol, 1,2,5-pentanetriol, 2-methyl-1,2,3-propanetriol, 2-methyl-1,2,4-butanetriol, and 1,2,3,6-hexatetraol. As the trihydric or higher polyhydric alcohol included in the cleaning solution, a trihydric or higher aliphatic alcohol is favorable, and glycerin or sorbitol is more favorable. As described above, by using diethylene glycol butyl methyl ether and a trihydric or higher polyhydric alcohol together in the cleaning solution, the diethylene glycol butyl methyl ether included in the cleaning solution is easily absorbed into the solidified ink.

The content ratio of the trihydric or higher polyhydric alcohol in the cleaning solution is favorably 1 mass % or more and 53 mass % or less. By setting the content ratio of the trihydric or higher polyhydric alcohol in the cleaning solution to 1 mass % or more, it is possible to reliably improve the cleaning performance of the cleaning solution. By setting the content ratio of the trihydric or higher polyhydric alcohol in the cleaning solution to 53 mass % or less, it becomes easier to ensure the compatibility with diethylene glycol butyl methyl ether.

In the case where the cleaning solution includes glycerin as a trihydric or higher polyhydric alcohol, the content ratio of diethylene glycol butyl methyl ether and the content ratio of glycerin in the cleaning solution favorably satisfies the following formula (1). Note that in the formula (1), A represents the content ratio (unit:mass %) of diethylene glycol butyl methyl ether in the cleaning solution and B represents the content ratio (unit:mass %) of glycerin in the cleaning solution.

$$- 7 \times A + 57 \leq B \leq - 7 \times A + 60 \qquad ( 1 )$$

For example, in the case where the content ratio of diethylene glycol butyl methyl ether in the cleaning solution is 8 mass %, the content ratio of glycerin in the cleaning solution is favorably 1 mass % or more and 4 mass % or less. Further, in the case where the content ratio of diethylene glycol butyl methyl ether in the cleaning solution is 4 mass %, the content ratio of glycerin in the cleaning solution is favorably 29 mass % or more and 32 mass % or less. In the case where the content ratio of diethylene glycol butyl methyl ether in the cleaning solution is 1 mass %, the content ratio of glycerin in the cleaning solution is favorably 50 mass % or more and 53 mass % or less.

When the content ratio of diethylene glycol butyl methyl ether and the content ratio of glycerin in the cleaning solution satisfies the formula (1), it is possible to optimize the cleaning performance of the cleaning solution. As a result, it is possible to more reliably weaken the adhesion force of the solidified ink to the ink ejection surface of the recording head and peel off and remove the solidified ink more easily.

Further, in the case where the cleaning solution includes sorbitol as a trihydric or higher polyhydric alcohol, the content ratio of diethylene glycol butyl methyl ether and the content ratio of sorbitol in the cleaning solution favorably satisfy the following formula (2). Note that in the formula (2), A represents the content ratio (unit:mass %) of diethylene glycol butyl methyl ether in the cleaning solution and C represents the content ratio (unit:mass %) of sorbitol in the cleaning solution.

$$- 5 \times A + 41 \leq C \leq - 5 \times A + 45 \qquad ( 2 )$$

for example, in the case where the content ratio of diethylene glycol butyl methyl ether in the cleaning solution is 8 mass %, the content ratio of sorbitol in the cleaning solution is favorably 1 mass % or more and 5 mass % or less. Further, in the case where the content ratio of diethylene glycol butyl methyl ether in the cleaning solution is 4 mass %, the content ratio of sorbitol in the cleaning solution is favorably 21 mass % or more and 25 mass % or less. In the case where the content ratio of diethylene glycol butyl methyl ether in the cleaning solution is 1 mass %, the content ratio of sorbitol in the cleaning solution is favorably 36 mass % or more and 40 mass % or less.

When the content ratio of diethylene glycol butyl methyl ether and the content ratio of sorbitol in the cleaning solution satisfy the formula (2), it is possible to optimize the cleaning performance of the cleaning solution. As a result, it is possible to more reliably weaken the adhesion force of the solidified ink to the ink ejection surface of the recording head and peel off and remove the solidified ink more easily.

The cleaning solution may include, as the organic solvent, an organic solvent other than diethylene glycol butyl methyl ether and a trihydric or higher polyhydric alcohol. However, the total content ratio of diethylene glycol butyl methyl ether and a trihydric or higher polyhydric alcohol in the organic solvent in the cleaning solution is favorably 90 mass % or more, more favorably 99 mass % or more, and still more favorably 100 mass %. In particular, the total content ratio of diethylene glycol butyl methyl ether and glycerin or sorbitol in the organic solvent in the cleaning solution is favorably 90 mass % or more, more favorably 99 mass % or more, and still more favorably 100 mass %.

### Water

As described above, the cleaning solution favorably includes water as a main solvent. The content ratio of water in the cleaning solution is favorably, for example, 40 mass % or more and 95 mass % or less, more favorably 60 mass % or more and 90 mass % or less.

### Additive

The cleaning solution may further include known additives (e.g., a dissolution stabilizer, an anti-drying agent, an antioxidant, a viscosity adjustor, a pH adjuster, and an antifungal agent) as necessary.

### Method of Producing Cleaning Solution

The cleaning solution can be produced by, for example, mixing diethylene glycol butyl methyl ether, a trihydric or higher polyhydric alcohol, and a component added as necessary (e.g., water). The ink set according to the first embodiment has been described above.

### Second Embodiment: Inkjet Recording Apparatus

An inkjet recording apparatus according to a second embodiment will be described below. The inkjet recording apparatus according to this embodiment includes an ink, a cleaning solution, and a recording head. The recording head includes a recording unit that ejects the ink onto an image forming region of a recording medium, and a cleaning unit that cleans an ink ejection surface of the recording unit with the cleaning solution. The drying ratio of the ink when left to stand at 40° C. for 24 hours is 87 mass % or more and 93 mass % or less. The cleaning solution includes diethylene glycol butyl methyl ether and a trihydric or higher polyhydric alcohol.

The ink and the cleaning solution included in the inkjet recording apparatus according to this embodiment are respectively the same as the ink and the cleaning solution included in the ink set according to the first embodiment. Therefore, the inkjet recording apparatus according to this embodiment is an inkjet recording apparatus that includes a recording head using the ink set according to the first embodiment. Therefore, the inkjet recording apparatus according to this embodiment is capable of easily removing the solidified highly drying inkjet ink by washing (cleaning) for the same reasons described in the first embodiment. Note that the details of the ink and the cleaning solution are omitted because they have been described in the first embodiment.

### Structure of Inkjet Recording Apparatus

The inkjet recording apparatus according to this embodiment will be described with reference to the drawings. Note that the drawings to be referred to schematically show mainly respective components for ease of understanding, and the size, number, and the like of each illustrated component are different from actual ones in some cases for the convenience of drawing creation. Further, the size, number, and the like of each illustrated component may be changed as appropriate.

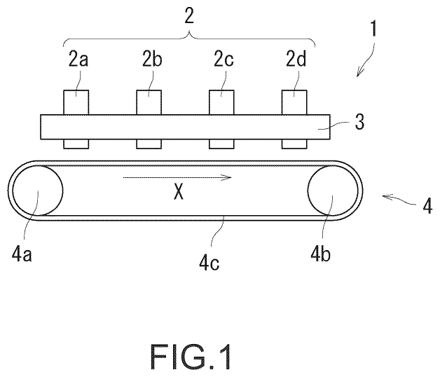

FIG. 1 is a diagram showing a main part of an inkjet recording apparatus 1 that is an example of the inkjet recording apparatus according to this embodiment. The inkjet recording apparatus 1 shown in FIG. 1 includes a recording head 2, a head housing 3 that holds the recording head 2, and a conveying unit 4 that conveys a recording medium (illustration omitted). The recording head 2 includes a first recording head 2a, a second recording head 2b, a third recording head 2c, and a fourth the recording head 2d. The conveying unit 4 includes a first roller 4a and a second roller 4b that are a pair of conveying rollers, and a conveyor belt 4c stretched between the first roller 4a and the second roller 4b. The conveying unit 4 conveys a recording medium placed on the conveyor belt 4c in a predetermined direction (right direction indicated by an arrow in FIG. 1). Hereinafter, the direction in which the recording medium is conveyed will be referred to as a conveying direction X in some cases. The first recording head 2a, the second recording head 2b, the third recording head 2c, and the fourth the recording head 2d eject the ink when the recording medium is conveyed directly below them to record an image (i.e., form an image).

Each of the first recording head 2a, the second recording head 2b, the third recording head 2c, the fourth the recording head 2d, and the conveying unit 4 is supported at a height such that the distance from the upper surface of the conveyor belt 4c is a predetermined length.

The first recording head 2a, the second recording head 2b, the third recording head 2c, and the fourth the recording head 2d records (forms) an image on the recording medium conveyed on the conveyor belt 4c.

Each of the first recording head 2a, the second recording head 2b, the third recording head 2c, and the fourth the recording head 2d is provided to be capable of housing the ink and the cleaning solution described in the first embodiment. Each of the first recording head 2a, the second recording head 2b, the third recording head 2c, and the fourth the recording head 2d includes an ink tank (ink housing unit) and a cleaning solution tank (cleaning solution housing unit), both of which are not shown.

The ink tanks of the first recording head 2a, the second recording head 2b, the third recording head 2c, and the fourth the recording head 2d house (store) inks of four different colors (black, cyan, magenta, and yellow) (a first ink, a second ink, a third ink, and a fourth ink). By using the highly drying ink described in the first embodiment as these inks, high-speed printing with these inks is made possible. Further, the cleaning solution tanks of the first recording head 2a, the second recording head 2b, the third recording head 2c, and the fourth the recording head 2d house (store) the cleaning solution described in the first embodiment.

Each of the first recording head 2a, the second recording head 2b, the third recording head 2c, and the fourth the recording head 2d ejects the ink of each color stored in the ink tank (not shown) onto a recording medium through a nozzle. Note that the first recording head 2a, the second recording head 2b, the third recording head 2c, and the fourth the recording head 2d each eject the ink onto a recording medium in a predetermined order with a predetermined ejection interval. In this way, a color image is formed on the recording medium.

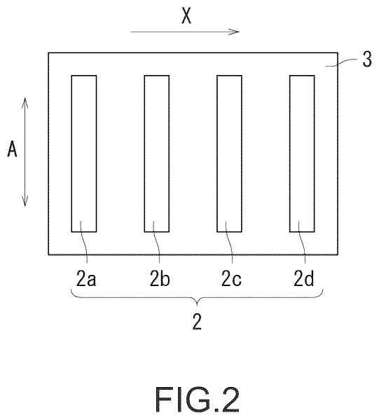

FIG. 2 is a diagram showing the lower surfaces of the recording head 2 and the head housing 3 in FIG. 1. Each of the first recording head 2a, the second recording head 2b, the third recording head 2c, and the fourth the recording head 2d extends in the direction (hereinafter, referred to as a width direction A in some cases) perpendicular to the conveying direction X.

The first recording head 2a, the second recording head 2b, the third recording head 2c, and the fourth the recording head 2d have substantially the same structure. For this reason, details of the recording head 2 will be described below using the first recording head 2a as an example. However, the same description applies to the second recording head 2b, the third recording head 2c, and the fourth the recording head 2d.

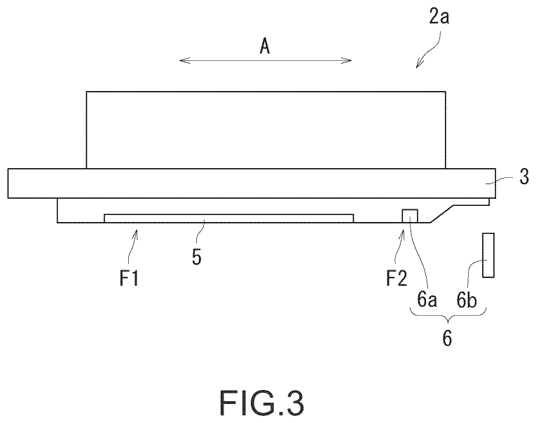

FIG. 3 is a diagram showing the side surface of the first recording head 2a in FIG. 1. As shown in FIG. 3, the first recording head 2a includes a recording unit 5 that ejects the ink onto the image forming region of the recording medium, and a cleaning unit 6 that cleans an ink ejection surface F1 of the recording unit 5 with the cleaning solution.

A plurality of nozzles (not shown) that ejects the ink is arranged on the ink ejection surface F1 on the lower surface of the recording unit 5.

As shown in FIG. 3, the cleaning unit 6 includes a cleaning solution supply unit 6a that is disposed in the vicinity of the ink ejection surface F1 of the recording unit 5, and a wiping blade 6b. A plurality of cleaning solution ejection hole (not shown) that ejects the cleaning solution is provided on a cleaning solution supply surface F2 on the lower surface of the cleaning solution supply unit 6a. The cleaning solution supply unit 6a supplies the cleaning solution stored in the cleaning solution tank (not shown) to the cleaning solution supply surface F2 through the cleaning solution ejection hole. The wiping blade 6b has the function of wiping the ink ejection surface F1. The wiping blade 6b is, for example, a rubber wiper. The line pressure of the wiping blade 6b is, for example, 5.0 N/m or more and 15.0 N/m or less.

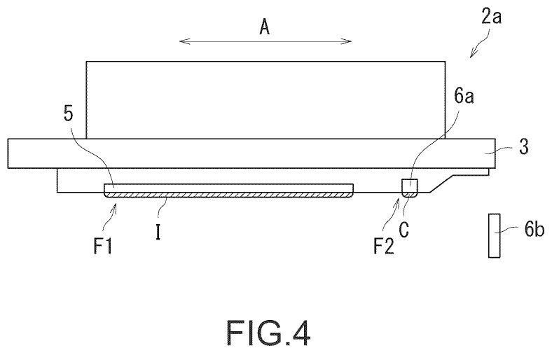

FIG. 4 to FIG. 7 each show a series of cleaning steps (a supplying step and a wiping step) of the cleaning operation by the inkjet recording apparatus 1. As shown in FIG. 4, in the cleaning operation, first, a small amount of ink I is purged from the recording unit 5 (purge operation). This eliminates the nozzle clogging and the like in the recording unit 5. The purged ink I adheres to the ink ejection surface F1 of the recording unit 5. In the cleaning operation, a cleaning solution C is supplied from the cleaning solution supply unit 6a (cleaning solution supply operation) simultaneously with the purge operation. The supplied cleaning solution C adheres to the vicinity of the ink ejection surface F1 of the recording unit 5 (the cleaning solution supply surface F2 on the lower surface of the cleaning solution supply unit 6a).

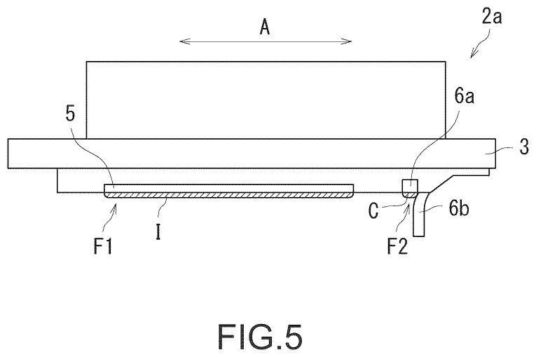

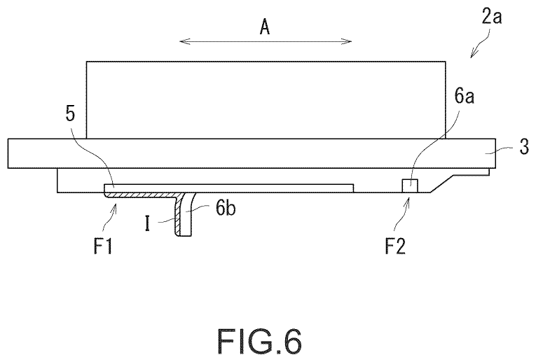

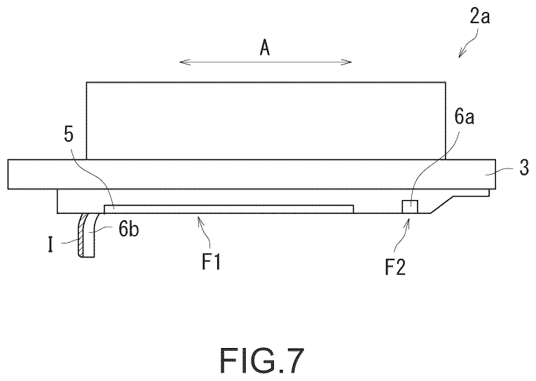

Next, as shown in FIG. 5, the wiping blade 6b is pressed against the cleaning solution supply surface F2 on the lower surface of the cleaning solution supply unit 6a. Next, as shown in FIG. 6, the wiping blade 6b moves horizontally (in the left direction in FIG. 6). As a result, the cleaning solution C is supplied to the ink ejection surface F1. The wiping blade 6b collectively wipes off the cleaning solution C adhered to the cleaning solution supply surface F2 and the ink I adhered to the ink ejection surface F1 (wipe operation). At this time, the cleaning solution C is mixed with the ink I. As a result, as shown in FIG. 7, the cleaning solution C adhered to the cleaning solution supply surface F2 and the ink I adhered to the ink ejection surface F1 are removed. In this way, the recording unit 5 is cleaned with the cleaning solution C.

The series of steps of the cleaning operation by the inkjet recording apparatus 1 has been described above. Note that each of the second recording head 2b, the third recording head 2c, and the fourth the recording head 2d also includes the recording unit 5 that ejects the ink and the cleaning unit 6 that cleans the ink ejection surface F1 of the recording unit 5 with the cleaning solution, similarly to the first recording head 2a. In also the second recording head 2b, the third recording head 2c, and the fourth the recording head 2d, the cleaning unit 6 includes the cleaning solution supply unit 6a that is disposed in the vicinity of the ink ejection surface F1 of the recording unit 5, and the wiping blade 6b.

Although an example of the inkjet recording apparatus according to this embodiment has been described above, the inkjet recording apparatus according to this embodiment is not limited to the one shown in FIG. 1 to FIG. 7.

In FIG. 1 to FIG. 7, the inkjet recording apparatus 1 that includes, as recording heads, four line-type recording heads corresponding to the inks of four colors has been described as an example. However, the number of recording heads included in the inkjet recording apparatus according to this embodiment is not particularly limited, can favorably be, for example, 1 or more and 10 or less, and is favorably 3 or more and 5 or less.

Further, in the inkjet recording apparatus according to this embodiment, the type, combination, and ejection order of inks are not particularly limited.

Further, in FIG. 1 to FIG. 7, the inkjet recording apparatus 1 in which the cleaning unit 6 includes the cleaning solution supply unit 6a that is disposed in the vicinity of the ink ejection surface F1 of the recording unit 5, and the wiping blade 6b has been described as an example. However, the inkjet recording apparatus according to this embodiment may be an inkjet recording apparatus in which the cleaning solution is directly applied to the wiping blade to perform a wipe operation. Further, the inkjet recording apparatus according to this embodiment may be an inkjet recording apparatus in which the cleaning solution is directly supplied (e.g., applied, scattered, or sprayed) to the ink ejection surface F1 of the recording unit 5 to perform a wipe operation. The cleaning unit of the inkjet recording apparatus according to this embodiment only needs to clean the ink ejection surface F1 of the recording unit 5 with the cleaning solution.

Further, the inkjet recording apparatus according to this embodiment may be a multifunction device that further has a function of a scanner, a copier, a printer, or a facsimile machine.

### Third Embodiment: Image Forming Method

An image forming method according to a third embodiment of the present disclosure will be described below. The image forming method according to this embodiment includes an ejection step of ejecting an ink onto a recording medium from an ink ejection surface of a recording head, and a cleaning step of cleaning the ink ejection surface with a cleaning solution. The ink includes a pigment and an aqueous medium. The drying ratio of the ink when left to stand at 40° C. for 24 hours is 87 mass % or more and 93 mass % or less. The cleaning solution includes diethylene glycol butyl methyl ether and a trihydric or higher polyhydric alcohol.

The ink and the cleaning solution used for the image forming method according to this embodiment are respectively the same as the ink and the cleaning solution included in the ink set according to the first embodiment. Therefore, the image forming method according to this embodiment is capable of easily removing the solidified highly drying inkjet ink by washing (cleaning) for the same reasons described in the first embodiment. Note that the details of the ink and the cleaning solution are omitted because they have been described in the first embodiment.

The image forming method according to this embodiment can be performed using, for example, the ink set according to the first embodiment. In the cleaning step, the ink included in the ink set according to the first embodiment is ejected onto a recording medium from the ink ejection surface of the recording head in the inkjet recording apparatus. In the cleaning step, the ink ejection surface is cleaned with the cleaning solution included in the ink set according to the first embodiment. The image forming method according to the third embodiment has been described above.

### EXAMPLES

Examples of the present disclosure will be described below. However, the present disclosure is not limited to the following Examples. Note that in the following description, water indicates ion exchanged water.

### Preparation of Ink

Inks (I-1) to (1-3) were prepared by the following method.

### Ink (I-1)

35.0 parts by mass of a pigment dispersion liquid (pigment: 35.0×20/100=7.0 parts by mass), 12.5 parts by mass of a binder resin particle dispersion liquid (binder resin particle: 12.5×40/100=5.0 parts by mass), 0.5 parts by mass of an acetylene glycol surfactant (“OLFINE (registered trademark) EXP.4300” manufactured by Nissin Chemical Co., Ltd.), 10.0 parts by mass of diethylene glycol monoethyl ether, 3.0 parts by mass of propylene glycol, and 39.0 parts by mass of water were sufficiently mixed using a stirrer (“Three-One Motor (registered trademark) BL-600” manufactured by Shinto Scientific Co., Ltd.). In this way, an ink (I-1) was prepared. Note that as the pigment dispersion liquid, “EMACOL SF BLACK AH2186F” manufactured by Sanyo Color Works, LTD. (pigment: C.I. Pigment Black 7, dispersion medium: water, pigment concentration: 20 mass %) was used. As the binder resin particle dispersion liquid, “Mowinyl (registered trademark) 6763” manufactured by Japan Coating Resin Co., Ltd. (binder resin particle dispersion liquid including urethane-acrylic resin, resin concentration: 40 mass %) was used.

### Ink (I-2)

An ink (I-2) was prepared in the same manner as that for the ink (I-1) except that 17.0 parts by mass of “SUPERFLEX (registered trademark) 870” manufactured by DKS Co. Ltd. (urethane resin emulsion, dispersion medium: water, solid content concentration: 30 mass %) (binder resin particle: 17.0×30/100=5.1 parts by mass) was used as the binder resin particle dispersion liquid instead of 12.5 parts by mass of “Mowinyl (registered trademark) 6763” and the amount of water used was changed from 39.0 parts by mass to 34.5 parts by mass. That is, the ink (1-2) was prepared by sufficiently mixing 35.0 parts by mass of “EMACOL SF BLACK AH2186F” (pigment: 7.0 parts by mass, water: 28.0 parts by mass), 17.0 parts by mass of “SUPERFLEX (registered trademark) 870” (binder resin particle: 5.1 parts by mass, water: 11.9 parts by mass), 0.5 parts by mass of “OLFINE (registered trademark) EXP.4300”, 10.0 parts by mass of diethylene glycol monoethyl ether, 3.0 parts by mass of propylene glycol, and 34.5 parts by mass of water using a stirrer (“Three-One Motor (registered trademark) BL-600” manufactured by Shinto Scientific Co., Ltd.).

### Ink (I-3)

An ink (1-3) was prepared in the same manner as that for the ink (I-2) except that the amount of propylene glycol used was changed from 3.0 parts by mass to 25.0 parts by mass and the amount of water used was changed from 34.5 parts by mass to 12.5 parts by mass. That is, the ink (I-3) was prepared by sufficiently mixing 35.0 parts by mass of “EMACOL SF BLACK AH2186F” (pigment: 7.0 parts by mass, water: 28.0 parts by mass), 17.0 parts by mass of “SUPERFLEX (registered trademark) 870” (binder resin particle: 5.1 parts by mass, water: 11.9 parts by mass), 0.5 parts by mass of “OLFINE (registered trademark) EXP.4300”, 10.0 parts by mass of diethylene glycol monoethyl ether, 25.0 parts by mass of propylene glycol, and 12.5 parts by mass of water using a stirrer (“Three-One Motor (registered trademark) BL-600” manufactured by Shinto Scientific Co., Ltd.).

### Preparation of Cleaning Solution

Cleaning solutions (C-1) to (C-9) and (c-1) to (c-12) were prepared by the following method.

### Cleaning Solution (C-1)

8.0 parts by mass of diethylene glycol butyl methyl ether, 4.0 parts by mass of glycerin, and 88.0 parts by mass of water were sufficiently stirred and mixed. In this way, a cleaning solution (C-1) was prepared.

### Cleaning solutions (C-2) to (C-9) and (c-1) to (c-12)

The cleaning solutions (C-2) to (C-9) and (c-1) to (c-12) were prepared in the same manner as that for the preparation of the cleaning solution (C-1) except that the types and addition amounts of raw materials used were changed as shown in the following Tables 1 to 4. Note that in the following Tables 1 to 4, “DEGBME” indicates diethylene glycol butyl methyl ether. Further, “PGMPE” indicates propylene glycol monopropyl ether. “EG” indicated ethylene glycol. “1,2-PG” indicates 1,2-propanediol. “1,3-PG” indicates 1,3-propanediol. “E1010” indicates a nonionic surfactant (“OLFINE (registered trademark) E1010” manufactured by Nissin Chemical Co., Ltd., ethylene oxide adduct of acetylenediol). The “part” indicates the parts by mass. “−” indicates that the corresponding component is not used. Glycerin and sorbitol are each a trihydric or higher polyhydric alcohol.

### Preparation of Ink Set

As shown in the following Tables 1 to 4, any of the inks (I-1) to (I-3) was combined with any of the cleaning solutions (C-1) to (C-9) and (c-1) to (c-12). In this way, ink sets according to Examples 1 toll and Comparative Examples 1 to 16 were prepared.

### Preparation of Sample Plate

A sample plate to be used for measurement to calculate the drying ratio of the ink and the removal ratio of the ink was prepared by the following method. First, 2 mL of the ink in the ink set to be evaluated was added dropwise to a stainless steel plate (SUS304) fixed to a spin coater, and the plate was caused to rotate for 3 seconds at the rotation speed of 2000 rpm. In this way, the ink in the ink set to be evaluated, which is a measurement target, was applied to the stainless steel plate by a spin coating method (at the application rate of 0.7 μL/cm²). Next, this stainless steel plate was left to stand at 40° C. for 24 hours to dry the applied ink. In this way, a stainless steel plate on which a dried thin film of the ink to be measured was formed was obtained as a sample plate.

### Drying Ratio of the Ink

The drying ratio of the ink when left to stand at 40° C. for 24 hours was calculated using the above-mentioned formula (i), W₀ being the mass of the ink applied to the stainless steel plate for the preparation of the sample plate, W₁ being the mass of the dried thin film of the ink formed on the sample plate. The drying ratios of the inks (I-1) to (1-3) calculated by the above-mentioned method are shown in Table 1 to 4 together with the content ratio of the volatile component in the inks (I-1) to (I-3). Note that in the following Tables 1 to 4, the “ratio of volatile component” indicates the content ratio of the volatile component in the inks (I-1) to (1-3). Note that in the ink (1-3), the drying ratio was decreased as compared with the inks (I-1) and (I-2) by increasing the amount of propylene glycol as compared with the inks (I-1) and (I-2).

### Removal Ratio of the Ink

0.1 mL of the cleaning solution in the ink set to be evaluated was added dropwise using a pipettor onto the dried thin film of the ink formed on the sample plate. Next, the dried thin film of the ink in the above-mentioned sample plate was wiped at the line pressure of 10 N/m using a rubber blade. The area x of a region where the dried thin film of the ink was peeled off and the underlying stainless steel plate was exposed in the portion of the sample plate with which the rubber blade was in contact after the wiping (region where the dried thin film of the ink was removed with the cleaning solution) was measured. The percentage of the area x relative to the total area of the portion of the sample plate with which the rubber blade was in contact was used as the removal ratio of the ink and used as the evaluation value of cleaning performance. The removal ratios of the inks (I-1) to (1-3) in each ink set calculated by the above-mentioned method are shown in Tables 1 to 4.

TABLE 1

| | | | Example | | | | | |
|---|---|---|---|---|---|---|---|---|
| | | | 1 | 2 | 3 | 4 | 5 | 6 |
| Cleaning | Type | | C-1 | C-2 | C-3 | C-4 | C-5 | C-6 |
| solution | Content | DEGBME | 8.0 | 8.0 | 4.0 | 1.0 | 1.0 | 8.0 |
| | ratio | PGMPE | — | — | — | — | — | — |
| | [parts] | EG | — | — | — | — | — | — |
| | | 1,2-PG | — | — | — | — | — | — |
| | | 1,3-PG | — | — | — | — | — | — |
| | | Glycerin | 4.0 | 1.0 | 32.0 | 53.0 | 50.0 | — |
| | | Sorbitol | — | — | — | — | — | 3.0 |
| | | E1010 | — | — | — | — | — | — |
| | | Water | 88.0 | 91.0 | 64.0 | 46.0 | 49.0 | 89.0 |

| | | | | | | |
|---|---|---|---|---|---|---|
| Type of ink | I-1 | I-1 | I-1 | I-1 | I-1 | I-1 |
| Ratio of volatile component [mass %] | 88 | 88 | 88 | 88 | 88 | 88 |
| Drying ratio of ink [mass %] | 88 | 88 | 88 | 88 | 88 | 88 |
| Removal ratio of ink [mass %] | 100 | 85 | 100 | 95 | 80 | 100 |

TABLE 2

| | | | Example | | | | |
|---|---|---|---|---|---|---|---|
| | | | 7 | 8 | 9 | 10 | 11 |
| Cleaning | Type | | C-7 | C-8 | C-9 | C-1 | C-9 |
| solution | Content | DEGBME | 8.0 | 1.0 | 1.0 | 8.0 | 1.0 |
| | ratio | PGMPE | — | — | — | — | — |
| | [parts] | EG | — | — | — | — | — |
| | | 1,2-PG | — | — | — | — | — |
| | | 1,3-PG | — | — | — | — | — |
| | | Glycerin | — | — | — | 4.0 | — |
| | | Sorbitol | 1.0 | 40.0 | 36.0 | — | 36.0 |
| | | E1010 | — | — | — | — | — |
| | | Water | 91.0 | 59.0 | 63.0 | 88.0 | 63.0 |

| | | | | | |
|---|---|---|---|---|---|
| Type of ink | I-1 | I-1 | I-1 | I-2 | I-2 |
| Ratio of volatile component [mass %] | 88 | 88 | 88 | 87 | 87 |
| Drying ratio of ink [mass %] | 88 | 88 | 88 | 87 | 87 |
| Removal ratio of ink [mass %] | 90 | 95 | 85 | 100 | 85 |

TABLE 3

| | | | Comparative Example | | | | | | | |
|---|---|---|---|---|---|---|---|---|---|---|
| | | | | 2 | 3 | 4 | 5 | 6 | 7 | 8 |
| Cleaning | Type | | c-1 | c-1 | c-2 | c-3 | C-4 | C-5 | C-6 | C-7 |
| solution | Content | DEGBME | 8.0 | 8.0 | 1.0 | — | — | — | — | 9.0 |
| | ratio | PGMPE | — | — | — | — | — | — | — | — |
| | [parts] | EG | — | — | — | — | — | — | — | — |
| | | 1,2-PG | — | — | — | — | — | — | — | — |
| | | 1,3-PG | — | — | — | — | — | — | — | — |
| | | Glycerin | — | — | — | 55.0 | 4.0 | — | — | — |
| | | Sorbitol | — | — | — | — | — | 40.0 | 3.0 | — |
| | | E1010 | — | — | — | — | — | — | — | — |
| | | Water | 92.0 | 92.0 | 99.0 | 45.0 | 96.0 | 60.0 | 97.0 | 91.0 |

| | | | | | | | | |
|---|---|---|---|---|---|---|---|---|
| Type of ink | I-1 | I-2 | I-1 | I-1 | I-1 | I-1 | I-1 | I-1 |
| Ratio of volatile component [mass %] | 88 | 87 | 88 | 88 | 88 | 88 | 88 | 88 |
| Drying ratio of ink [mass %] | 88 | 87 | 88 | 88 | 88 | 88 | 88 | 88 |
| Removal ratio of ink | 70 | 60 | 20 | 0 | 0 | 0 | 0 | Unmeasurable |
| [mass %] | | | | | | | | |

TABLE 4

| | | | Comparative Example | | | | | | | |
|---|---|---|---|---|---|---|---|---|---|---|
| | | | 9 | 10 | 11 | 12 | 13 | 14 | 15 | 16 |
| Cleaning | Type | | c-8 | c-9 | c-10 | c-11 | c-1 | c-12 | c-12 | c-12 |
| solution | Content | DEGBME | 8.0 | 8.0 | 8.0 | 1.0 | 8.0 | — | — | — |
| | ratio | PGMPE | — | — | — | — | — | 20.0 | 20.0 | 20.0 |
| | [parts] | EG | 4.0 | — | — | — | — | — | — | — |
| | | 1,2-PG | — | 4.0 | — | — | — | — | — | — |
| | | 1,3-PG | — | — | 4.0 | 53.0 | — | — | — | — |
| | | Glycerin | — | — | — | — | — | — | — | — |
| | | Sorbitol | — | — | — | — | — | — | — | — |
| | | E1010 | — | — | — | — | — | 0.5 | 0.5 | 0.5 |
| | | Water | 88.0 | 88.0 | 88.0 | 46.0 | 92.0 | 79.5 | 79.5 | 79.5 |

| | | | | | | | | |
|---|---|---|---|---|---|---|---|---|
| Type of ink | I-1 | I-2 | I-1 | I-1 | I-3 | I-1 | I-2 | I-3 |
| Ratio of volatile component [mass %] | 88 | 87 | 88 | 88 | 87 | 88 | 87 | 87 |
| Drying ratio of ink [mass %] | 88 | 87 | 88 | 88 | 70 | 88 | 87 | 70 |
| Removal ratio of ink [mass %] | 60 | 55 | 60 | 10 | 100 | 0 | 0 | 100 |

As shown in Table 1 to Table 4, the inks (I-1) and (I-2) are each a highly drying pigment ink that includes a pigment and an aqueous medium, the drying ratio of the ink when left to stand at 40° C. for 24 hours being 88 mass % or more. The ink sets according to Examples 1 to 11 included the ink (I-1) or (1-2) and any of the cleaning solutions (C-1) to (C-9). The cleaning solutions (C-1) to (C-9) are each include diethylene glycol butyl methyl ether and glycerin or sorbitol that is a trihydric or higher polyhydric alcohol. For this reason, the cleaning solutions (C-1) to (C-9) each had the removal ratio of the ink of 80% or more and were capable of easily peeling off and removing the dried thin film of the highly drying pigment ink adhered to the sample plate.

On the other hand, the cleaning solution (C-1) of the ink sets according to Comparative Examples 1, 2, and 13 did not include a trihydric or higher polyhydric alcohol. For this reason, although the cleaning solution (C-1) exhibited sufficient cleaning performance for the ink (1-3) with the drying ratio when being left to stand at 40° C. for 24 hours being low, i.e., 70 mass %, as in Comparative Example 13, it did not exhibit sufficient cleaning performance for the inks (I-1) and (1-2) with high drying ratios and the removal ratio of the ink was lower than those in Examples. Similarly, the cleaning solution (c-2) of the ink set according to Comparative Example 3 did not include a trihydric or higher polyhydric alcohol, and thus, its cleaning performance was inferior to those of the cleaning solutions used in Examples.

The cleaning solutions (c-3) to (c-6) according to Comparative Examples 4 to 7 did not include diethylene glycol butyl methyl ether. For this reason, the cleaning solutions (c-3) to (c-6) did not exhibit cleaning performance for the inks (I-1) and (1-2) with high drying ratios and were unable to peel off and remove the dried thin film.

The cleaning solution (c-7) according to Comparative Example 8 did not include a trihydric or higher polyhydric alcohol and include diethylene glycol butyl methyl ether mixed in water in the amount exceeding the solubility in water. For this reason, in Comparative Example 8, the cleaning solution (c-7) was separated and its cleaning performance was unable to be evaluated.

In each of the cleaning solutions (c-8) to (c-11) according to Comparative Examples 9 to 12, a divalent alcohol was used instead of a trihydric or higher polyhydric alcohol. As a result, in Comparative Examples 9 to 12, the effect of improving cleaning performance was not achieved, but rather, the cleaning performance was reduced, as compared with the case where the cleaning solution (C-1) according to Comparative Example 1, which did not include a polyhydric alcohol, was used.

The cleaning solution (c-12) according to Comparative Examples 14 to 16 is the cleaning solution disclosed in Patent Literature 1, which includes propylene glycol monopropyl ether, a nonionic surfactant, and water. The cleaning solution (c-12) did not include diethylene glycol butyl methyl ether and a trihydric or higher polyhydric alcohol. For this reason, although the cleaning solution (c-12) exhibited sufficient cleaning performance for the ink (1-3) with the drying ratio when being left to stand at 40° C. for 24 hours being low, i.e., 70 mass %, as in Comparative Example 16, it was unable to clean the inks (I-1) and (I-2) with high drying ratios.

It should be understood by those skilled in the art that various modifications, combinations, sub-combinations and alterations may occur depending on design requirements and other factors insofar as they are within the scope of the appended claims or the equivalents thereof.

What is claimed is:

1. An ink set, comprising:
an inkjet ink; and
a cleaning solution,
the inkjet ink including a pigment and an aqueous medium,
a drying ratio of the inkjet ink when left to stand at 40° C. for 24 hours being 87 mass % or more and 93 mass % or less,
the cleaning solution including diethylene glycol butyl methyl ether and a trihydric or higher polyhydric alcohol.

2. The ink set according to claim 1, wherein
the inkjet ink further includes a binder resin particle, and
a content ratio of a volatile component in the inkjet ink is 85 mass % or more and 93 mass % or less.

3. The ink set according to claim 1, wherein
the polyhydric alcohol is glycerin or sorbitol.

4. The ink set according to claim 1, wherein
a content ratio of the diethylene glycol butyl methyl ether in the cleaning solution is 1 mass % or more and 8 mass % or less.

5. The ink set according to claim 4, wherein
the polyhydric alcohol is glycerin or sorbitol, and
the content ratio of the diethylene glycol butyl methyl ether and a content ratio of the glycerin in the cleaning solution satisfy the following formula (1), or
the content ratio of the diethylene glycol butyl methyl ether and a content ratio of the sorbitol in the cleaning solution satisfy the following formula (2):
$$- 7 \times A + 57 \leq B \leq - 7 \times A + 60 \qquad ( 1 )$$
wherein, in the formula (1), A represents the content ratio of the diethylene glycol butyl methyl ether in the cleaning solution and B represents the content ratio of the glycerin in the cleaning solution;
$$- 5 \times A + 41 \leq C \leq - 5 \times A + 45 \qquad ( 2 )$$
wherein, in the formula (2), A represents the content ratio of the diethylene glycol butyl methyl ether in the cleaning solution and C represents the content ratio of the sorbitol in the cleaning solution.

6. An inkjet recording apparatus, comprising:
an inkjet ink;
a cleaning solution; and
a recording head,
the recording head including
a recording unit that ejects the inkjet ink onto an image forming region of a recording medium, and
a cleaning unit that cleans an ink ejection surface of the recording unit with the cleaning solution,
a drying ratio of the inkjet ink when left to stand at 40° C. for 24 hours being 87 mass % or more and 93 mass % or less,
the cleaning solution including diethylene glycol butyl methyl ether and a trihydric or higher polyhydric alcohol.

7. An image forming method, comprising:
an ejection step of ejecting an inkjet ink onto a recording medium from an ink ejection surface of a recording head; and
a cleaning step of cleaning the ink ejection surface with a cleaning solution,
the inkjet ink including a pigment and an aqueous medium,
a drying ratio of the inkjet ink when left to stand at 40° C. for 24 hours being 87 mass % or more and 93 mass % or less,
the cleaning solution including diethylene glycol butyl methyl ether and a trihydric or higher polyhydric alcohol.

8. The image forming method according to claim 7, wherein
the cleaning step includes
a supplying step of supplying the cleaning solution to the ink ejection surface, and
a wiping step of wiping the ink ejection surface with a wiping blade.
